(19) United States
(12) Patent Application Publication
(10) Pub. No.: US 2009/0066150 A1
(43) Pub. Date: Mar. 12, 2009

(54) Cam Action Caster Assembly for Ride-On Devices

(76) Inventor: Thomas Joseph O'Rourke, SR., Harlingen, TX (US)

Correspondence Address: WADDEY & PATTERSON, P.C., 1600 DIVISION STREET, SUITE 500, NASHVILLE, TN, 37203, US

(21) Appl. No.: 12/208,129

(22) Filed: Sep. 10, 2008

Related U.S. Application Data
(60) Provisional application No. 60/971,257, filed on Sep. 10, 2007.

(51) Int. Cl. B60B 33/00; B62M 1/00

(52) U.S. Cl. 301/5.23; 280/87.01

(57) ABSTRACT

A caster assembly includes a wheel bracket, a wheel attached to the wheel bracket, a shaft about which the wheel bracket is free to rotate, and a cam assembly. The caster assembly is attached to the underside of a caster board, where the shaft is fixed perpendicular to the board, and the cam assembly comprises a cam track fixed to the board with the shaft at its center and a cam follower fixed to the wheel bracket. The cam track is geometrically formed to have a number of valleys and peaks along its circumference. As the wheel bracket rotates about the shaft, the cam follower engages the cam track and causes the board and the wheel assembly to move away and towards each other. The resulting forces generate or maintain a generally forward motion in the caster board, without the need for further efforts by a rider. The caster assembly further permits the rider to travel backwards as well as forwards. The cam track is easily changeable by the rider to accommodate various user preferences and skill levels.

### CROSS-REFERENCES TO RELATED APPLICATIONS

This application claims benefit of the following patent application which is hereby incorporated by reference: U.S. patent No. 60/971,257, filed Sep. 10, 2007

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates generally to caster assemblies. More particularly, in various embodiments, the present invention relates to caster assemblies for use with ride-on devices. Even more specifically, this invention, in particular embodiments, pertains to an adjustable cam action assembly for improved performance of recreational skate boards, caster boards, and the like.

There are numerous ride-on devices in the marketplace. Ride-on devices take many forms and may be used for exercise, entertainment or both. They may have a nondescript, mostly functional aesthetic form, like a skateboard or scooter, or they may be made to look like a vehicle, an animal or a fictional character as with many preschool toys.

Conventional skate boards are generally supported by two-wheeled truck assemblies attached to the undersides of the boards. Such skate boards have long been popular, but are limited in the sense that the rider could realistically accelerate on a level or uphill surface only by removing one of his or her feet from the board and pushing off the ground. Typical such skate boards were also limited in the degree of steering that was possible, as where the turning radius reached a certain angle, the wheels would touch the board.

There is a desire and need in the marketplace for ride-on products that can be propelled in a way that is more novel than simply pushing off, and that may provide sharper turns if desired.

Caster boards were subsequently developed to address the limitations of skate boards. U.S. Pat. No. 7,195,259 provides certain examples of caster boards. Caster boards typically have comprised one or two boards, with at least one swivel caster wheel assembly in front and at least one in the rear of the caster board. The rider twists his or her body to the left and to the right to accelerate the caster board or to turn it within a relatively small turning radius. This is accomplished by having the wheels rotate around the wheel axis when the board is twisted in either direction, where the axis is angled with respect to the bottom of the caster board.

In prior art caster boards, the board rises and falls at a rate predetermined by angle of attachment of the axis as the wheel bracket rotates. The angle can be made steep or slight or somewhere in between by the angle of the connection of the axis. Therefore the ease of operation and speed are inversely proportional to each other within this design and both must be compromised, in typical prior art designs, to achieve a balance between them. Moreover, in common prior art caster boards, the angle of the axis cannot be adjusted by the rider, according to his skill level, chosen activity or preference. In contrast, many sport type ride-on devices, such as BMX bicycles and common skateboards, retain the interest of the user partly due to the fact they can be customized to affect performance via changeable parts such as sprockets, trucks and other paraphernalia.

Typical prior art caster boards with a fixed angle design are also limited in that propulsion is only unidirectional. This is because most caster boards use the lateral force against the supported weight and the rise of the board as the wheel caster rotates to propel the board. With the angled shaft design there is only one low point on the rotation of the wheel assembly. If the wheel assembly is rotated 180 degrees, the base of the ride-on device is at its highest point, no further rise is possible, and so it cannot be propelled in this direction.

Some ride-on devices have used a spring to work against the rotation of the wheel assembly along the wheel axis, thus creating a force that replaces the gravitational force used in other prior art devices. This method still provides forward motion resulting from side-to-side, or twisting, forces applied by the rider. However, this does not allow full rotation of the wheel assembly which limits the maneuverability of the ride-on device. Moreover, the spring has a set tension so performance varies greatly with the weight of the rider.

It is desirable therefore to provide a caster assembly that permits full rotation of the wheel for improved maneuverability. This improved performance may include sharper turns, bi-directional travel, and user-adjustable components for various preferences and/or skill levels as examples. Other needs and potential areas for benefit may be apparent to persons of skill in the art having studied this document.

### BRIEF SUMMARY OF THE INVENTION

It is an object of some embodiments of this invention to provide a caster assembly for ride-on devices such as caster boards that uses a cam to permit bidirectional motion, improve performance, or both, for example, for riders of all sizes. Some embodiment may have other objects or benefits, some of which may be apparent from this document.

In accordance with some embodiments of the invention, a caster assembly includes a wheel bracket, a wheel attached to the wheel bracket, a shaft about which the wheel bracket is free to rotate, and a cam assembly, for example. In some embodiments, the caster assembly is attached to the underside of a caster board, for instance where the shaft is fixed perpendicular to the board, and the cam assembly may comprise a cam track fixed to the board with the shaft at its center, for example, and a cam follower may be fixed to the wheel bracket in some embodiments. The cam track is geometrically formed to have a number of valleys and peaks along its circumference, in various embodiments. Oscillating lateral forces applied by the rider may cause the wheel bracket to rotate about the shaft and the cam follower to engage and track the valleys and peaks in the cam track, for example. The resulting forces may operate to cause the wheels to roll and maintain a generally forward motion in the caster board, without the need for further efforts by a rider.

Through the use of various embodiments of the invention, forward motion may be easier to maintain than it is to initiate. Further, in a number of embodiments, the caster assembly further permits the rider to travel backwards as well as forwards. In different embodiments, the cam track may comprise a wide variety of configurations and some embodiments may be easily changeable by the rider to accommodate various user preferences and skill levels, for example. As used herein, “changeable”, when referring to a part such as a cam track, means that the part can be removed and replaced without damaging the part using the skill and tools ordinarily found in homes of most riders of skateboards, caster boards, scooters, and the like.

In accordance with other embodiments of the caster assembly, the cam track may be attached to the wheel bracket and may actually rotate with the wheel bracket. In some such embodiments, the cam follower(s) is/are fixed to the underside of the caster board, for example, and thus continue(s) to engage the cam track as it rotates around the shaft. In this manner the caster assembly may allow for a variety of cam configurations where aesthetically desirable or functionally necessary, while still maintaining some or all of the improved capabilities of the previously disclosed embodiments.

While many ride-on devices as contemplated by this invention may require more than one wheel to operate, only one propulsion caster assembly as described may be required. However, the various caster assemblies of the present invention may be used in a variety of combinations with a variety of ride-on devices in some embodiments. The caster assembly may, in addition, comprise a blade instead of a wheel where the ride-on device is to be used on ice. Further, the caster assembly may conceivably be used with devices that are not intended to be ridden such as carts or wagons, as examples.

### BRIEF DESCRIPTION OF THE SEVERAL VIEWS OF THE DRAWINGS

FIGS. 1A and 1B contain a side view and an end view of one embodiment of a caster assembly of the present invention as associated with a caster board.

FIG. 2 is an end view of one embodiment of a caster assembly of the present invention (no caster wheel attached).

FIG. 3 contains an exploded perspective view of the caster assembly of FIG. 2 (no caster wheel included).

FIGS. 4A to 4C contain side, perspective, and front views of a wheel, wheel bracket and cam assembly used in one embodiment of the invention.

FIGS. 5A to 5C contain side, perspective and front views of another embodiment of the invention.

FIG. 6 is a side view of another embodiment of a caster assembly in accordance with the present invention (without a wheel attached).

FIGS. 7A to 7C contain top, side, and end views of one embodiment of a cam track used with a caster assembly of the present invention.

FIGS. 8A and 8B contain side and rear views of another embodiment of a caster assembly in accordance with the present invention.

FIG. 9 is an exploded perspective view of another embodiment of a caster assembly in accordance with the present invention.

FIG. 10 is a perspective view of another embodiment of a caster assembly in accordance with the present invention.

FIG. 11 is a perspective view of another embodiment of a caster board using the caster assembly of the present invention.

FIG. 12 is a perspective view of still another embodiment of a caster board using a caster assembly of the present invention.

### DETAILED DESCRIPTION OF THE INVENTION

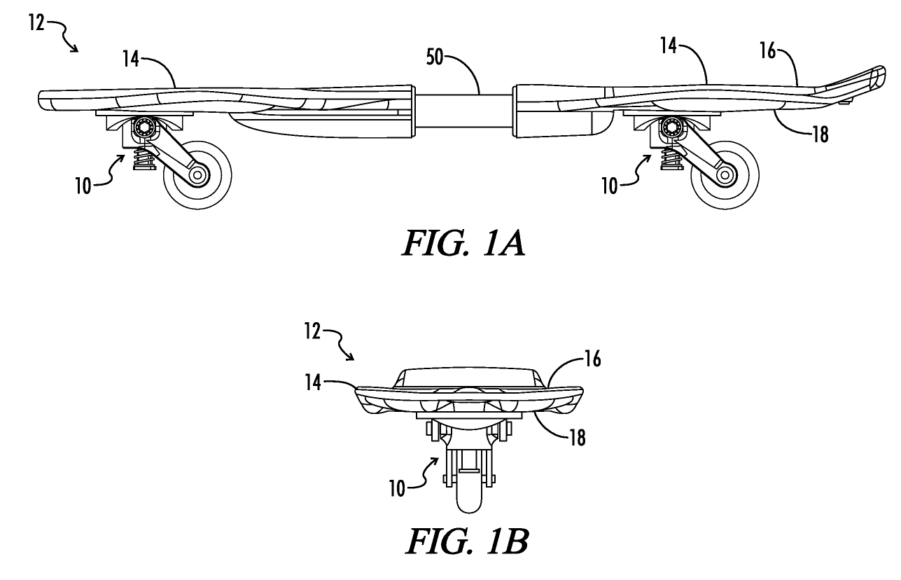

One embodiment of the invention is disclosed in FIGS. 1A and 1B. In this embodiment, a cam action caster assembly 10 is presented for use with a ride-on device 12 having at least one base 14. Each base 14 has a top side 16 for supporting the feet of a rider and a bottom side 18 to which the caster assembly 10 is attachable.

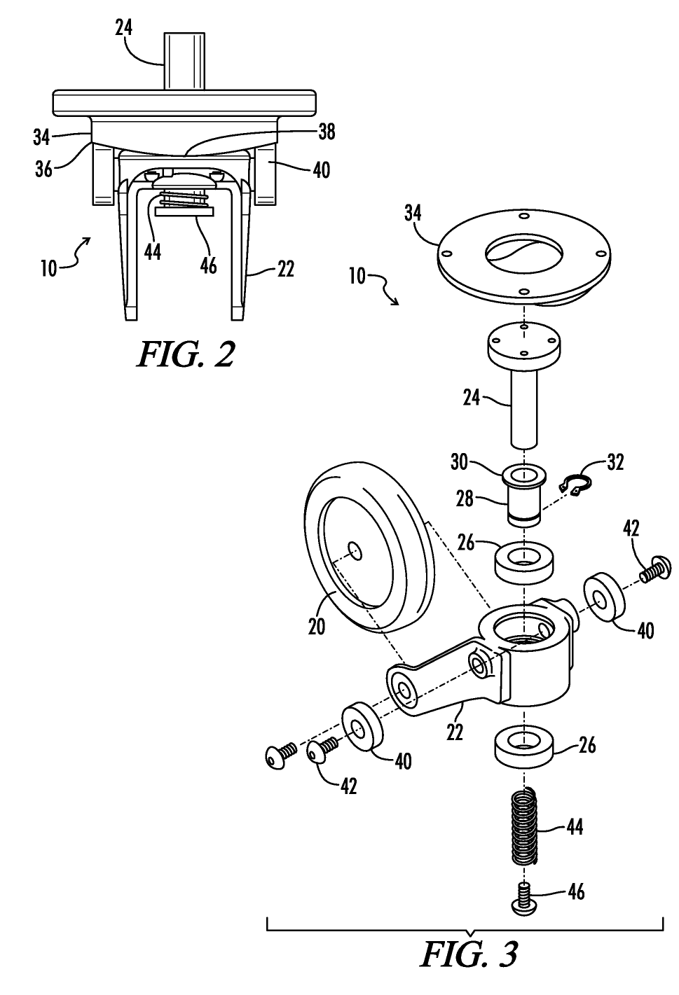

Referring now to FIGS. 2 and 3, in the embodiment illustrated, the caster assembly 10 includes a wheel 20 supported by a wheel bracket 22. The wheel 20 is attached so as to rotate freely along its entire circumference. In this embodiment, the wheel bracket 22 is rotatably connected to a shaft 24 that is fixed perpendicular to the bottom side 18 of the base 14. In this manner the wheel 20 and the wheel bracket 22 are free to rotate around the shaft 24 and about an axis generally forming a right angle with respect to the base 14. The benefits of this axis of rotation will be discussed below.

In some embodiments, friction on the shaft 24 may be reduced, for example, by the use of shaft radial bearings 26 engaging both wheel bracket 22 and shaft 24. Bearings 26 may be secured to wheel bracket 22 by a bushing 28 having a flange or lip 30 on one side (e.g., on the top) and an external snap ring 32 on the other side (e.g., on the bottom), for example. Once so secured, the bushing 28 may then slide on shaft 24, for instance.

Referring to FIG. 1, in the embodiment illustrated, cam track 34 is attached to the bottom side 18 of base 14 with shaft 24 at its center. In various embodiments, cam track 34 is shaped such that it has at least on valley 36 and one peak 38. In the embodiment shown, the two lowest points or valleys 36 of the cam track 34 face to the left and to the right of the ride-on device 12 with respect to motion or a direction in which the device 12 is normally ridden, for example, the long axis or long horizontal dimension of the device 12. Likewise, the two highest points or peaks 38 of the cam track 34 face forward and to the back of the ride-on device 12 with respect to the normal direction of motion. In other embodiments, the valleys 36 of the cam track 34 may be in front of and behind shaft 24 or at other locations along cam track 34.

In the embodiment shown, a cam follower is attached to the wheel bracket 22 by cam bolts 42. In some embodiments, the cam follower comprises roller followers or cam track radial bearings 40. The cam track bearings 40 may be secured to the wheel bracket 22 so as to be parallel to each other and to the wheel 20 at all times. The cam track bearings 40 are also equidistant from the center of the wheel bracket 22 at a distance equal to the radius of the cam track 34 in the embodiment shown. Upon rotation of the wheel bracket 22, each of the cam track bearings 40 engages the cam track 34. In the embodiment shown, as the cam track bearings 40 engage and trace the cam track 34 from a low point 36 to a high point 38, a distance between the wheel 20 and the base 14 subsequently increases. Likewise, as the cam track 34 is followed by cam track bearings 40 from the high point 38 back to a low point 36, the distance between the wheel 20 and the base 14 decreases. As such, the more pronounced the difference between the valleys 36 and peaks 38 of the geometry of the cam track 34, the greater the effect on the distance between the wheel 20 and the base 14, with results that will become apparent below.

In some embodiments of the caster assembly 10, for example, a helical spring 44 is positioned over the end of shaft 24 and may be secured in place by subsequently threading a shaft bolt 46 into the end, for instance. As the wheel bracket 22 rotates around cam track 34, in this embodiment spring 44 is compressed by wheel bracket 22 traveling down or away from bottom side 18 of base 14. In this embodiment, spring 44 acts to keep wheel 20 and wheel bracket 22 from rotating freely (i.e., around shaft 24) when wheel 20 is not making contact with a riding surface, such as during an airborne maneuver, for example.

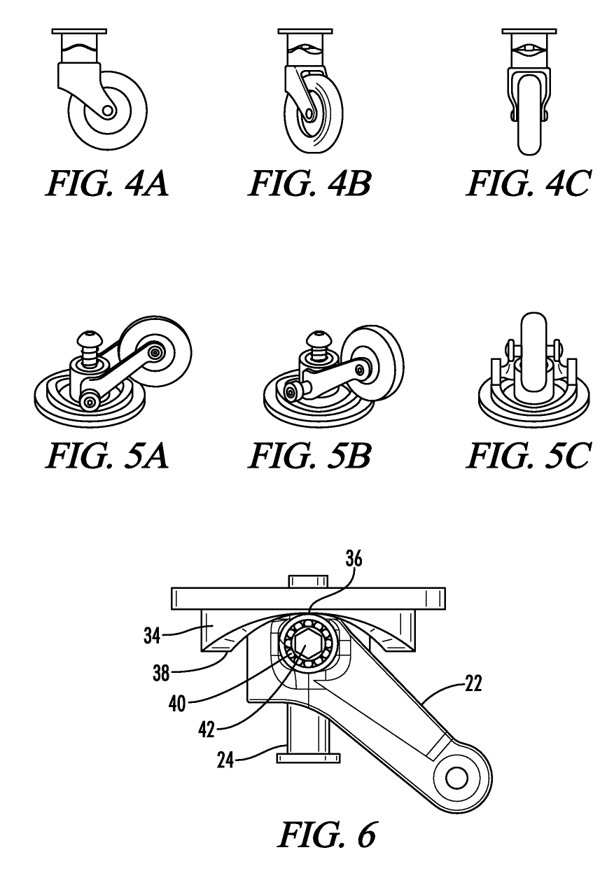

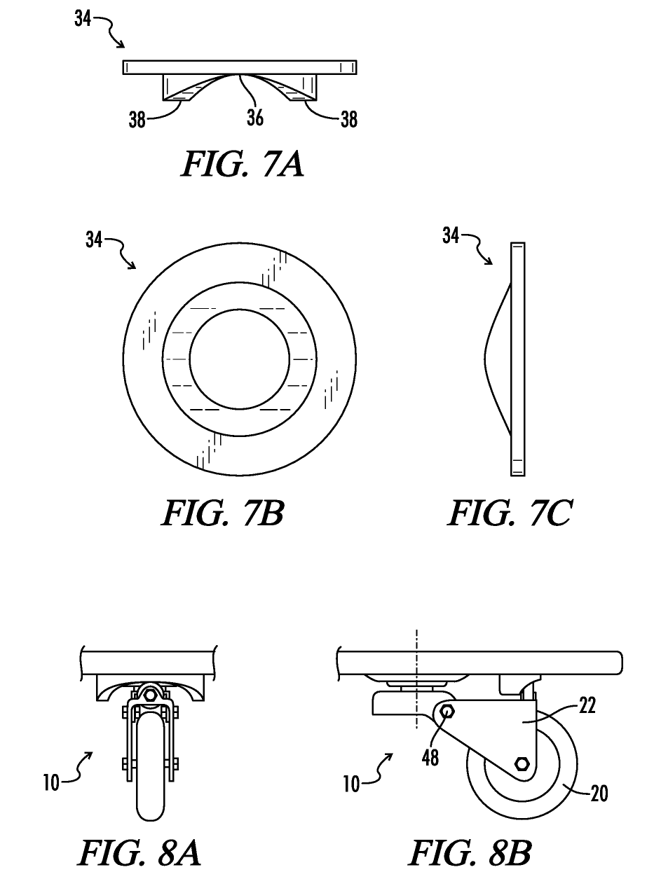

FIGS. 4A to 4C illustrate another embodiment of a caster assembly having a cam. Other embodiments of the caster assembly 10 of the present invention can be viewed in FIGS. 5A to 6. FIGS. 7A to 7C demonstrate an embodiment of the cam track 34 specifically. Although not shown in FIG. 7B, in a number of embodiments cam track 34 may contain holes for fasteners to secure cam track 34 to base 14, for example (e.g., as shown in FIG. 3).

With one or more caster assemblies 10 as described mounted to a ride-on device 12, in this example a caster board, motion may be started with a push by the rider. The supported weight on cam bearings 40 causes them to seek the valleys 36 of the cam track 34. As a sufficient twisting and/or side-to-side force is applied, e.g., swizzling, the cam bearings 40 overcome this tendency in proportion to the twisting and/or the side to side force applied. As a result, the cam bearings 40 travel from the valley 36 of the cam track 34 toward the peak 38 of same.

With the cam action of this embodiment of the invention as described, the rise and fall of the base 14 is not limited to a predetermined rate by the axis angle of attachment as the wheel bracket 22 rotates. Using a cam allows more control over the rise and fall of the device, and therefore more control over performance when compared to an angled caster without a cam. By its shape, the cam track 34 can cause the base 14 to rise and fall modestly at first and accelerate the angle of action as the caster assembly 10 rotates further around the cam track 34 and its axis. This means that a cam track 34 can make the ride-on device 12 easy to set into beginning motion, yet still offer the potential for greater speed within a single configuration. Therefore a cam track 34 effectively reduces the opposition of these two characteristics of performance in a ride-on device 12 using such a caster assembly 10.

For example, a cam track 34 having a steeper angular incline with respect to the base 14 may raise the base 14 higher and more quickly, and permit the rider to move the device at greater speeds when side to side force is applied, with the caveat that such an angle may make the ride-on device 12 more difficult to set in motion and control. A cam track 34 with a flatter angular incline with respect to the base 14 will facilitate easier starts and enable turns and tricks such as a 180 or 360 degree spin, for example. However, a flatter angular incline will decrease the ability to accelerate to higher speeds.

A cam track 34 having a wider radius also allow greater speeds with a lower profile cam track. As such, some embodiments of the invention offer a variety of configurations of cam tracks 34 that may easily be changeable by the rider, for example, to adjust the performance of the ride-on device 12 to match skill level, chosen activity or preference. In some embodiments, a cam track 34 may be changeable simply be detaching it from the base 14 using conventional fasteners and may be interchangeable with other shape or height cam tracks 34, for example. Where a wider radius for the cam track 34 is desired for improved leverage and greater response by the caster assembly 10 to lateral forces, other components such as the cam bearings 40 may also be detachable and interchangeable.

In various embodiments of ride-on devices 12, the most stable positions of the device 12 are where the caster 10 is at its low points 36. This is because gravity always causes the device 12 to seek its lowest point. The higher the base 14 is pushed by the rotation of the caster 10, the more it gravitates toward a lower position. With the cam track 34 of certain embodiments, including the embodiments shown, complementing low positions 36 are available in both the forward and back positions of the cam track 34 relative to normal motion of ride-on device 12. This makes changing the direction of the ride-on device 12 (e.g., going backwards) a more stable activity than was possible previously, e.g., with angle-axis caster devices. This opens up a variety of tricks that can be better executed by various embodiments of the invention.

In another embodiment of the invention, a specialty “trick track” cam track 34 with smaller valleys 36 every ninety degrees rather than merely in the front and rear of the ride-on device 12 can be attached to the caster assembly 10 by the rider, for example. This will make the ride-on device 12 more stable north, south, east and west and able to propel itself in each of these directions. This opens up more possibilities for dancing or freestyle activities, for example.

Another significant advantage of some embodiments of the invention resides in the integrity of the attachment of the caster assembly 10 to bottom side 18 of base 14. Cam track 34 allows a vertical attachment as opposed to an angled attachment. Therefore less bending moment is exerted on the connection point when a downward force is applied (such as the weight of the rider, particularly during some sort of landing as from a trick). Because of the bending moment an angle creates, an angled attachment actually acts as a lever to increase force on the single attachment point of the caster. Conversely, the disclosed cam track 34 serves as an additional support for the caster assembly 10, in some embodiments. This relieves stress placed upon the connection point when a downward force is applied by distributing the force over an exponentially wider area.

Referring now to FIGS. 8A and 8B, in another embodiment of the invention, the caster assembly 10 further includes pivot hinge 48 on wheel bracket 22 such that wheel bracket 22 no longer needs to travel up and down shaft 24. A helical or other shape spring may be affixed to the pivot hinge 48 in this embodiment for the same reason that the helical spring 44 was positioned over the shaft 24 in other embodiments.

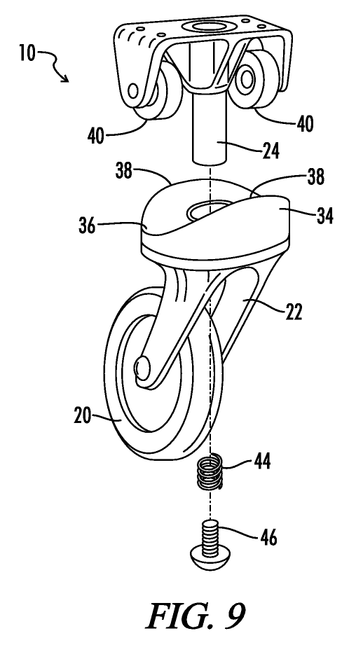

In another embodiment of the invention as displayed in FIG. 9, cam track 34 is attached to, or is integral with, wheel bracket 22 and rotates with wheel bracket 22. In this embodiment, cam follower or cam bearing 40 is fixed (from rotating about shaft 24, although cam bearings 40 are free to rotate about their own axes) to the bottom side 18 of the base 14, and engages cam track 34 as it rotates around shaft 24. In other embodiments, shaft 24 may rotate with cam track 34. In this manner, caster assembly 10 allows for a variety of cam configurations where aesthetically desirable or functionally necessary, while still maintaining, in some embodiments, some or all of the improved capabilities of the previously disclosed embodiments.

In the particular embodiment of the invention specifically illustrated in FIGS. 1A and 1B, the ride-on device 12 comprises two bases 14 connected to each other with a connecting element 50 and having one caster assembly 10 attached to the bottom side 18 of each base 14. In various embodiments, boards 14 may be adapted to support a rider's feet. For example, boards 14 may be of sufficient strength to support a rider and may be made of a material having a relatively high coefficient of friction with the sole of a typical shoe that may be worn when riding a ride-on device 12 of the embodiment. The caster assembly 10 may also work with numerous other embodiments of ride-on devices 12.

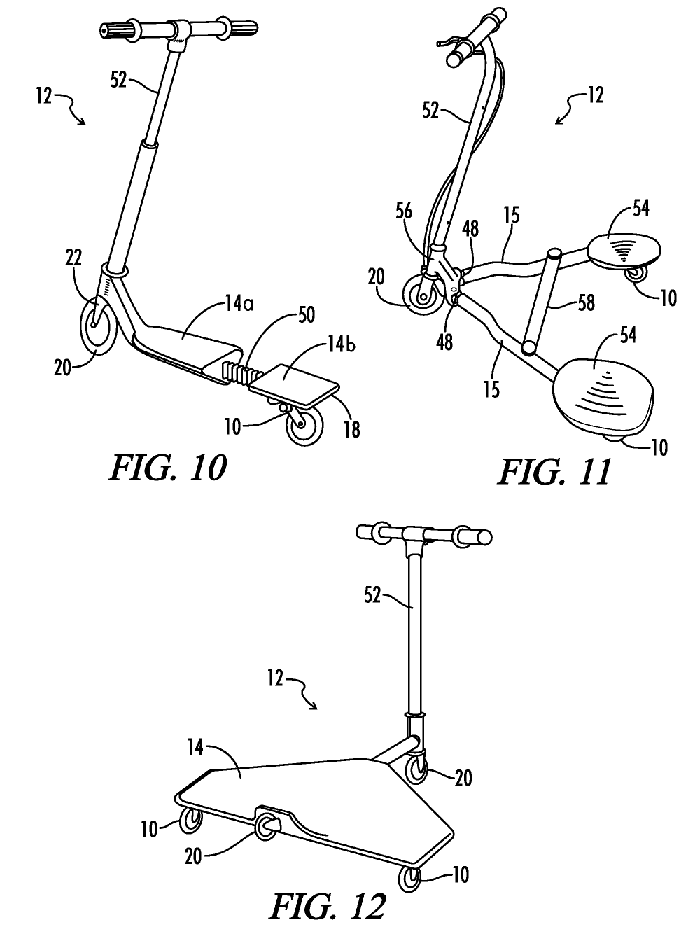

FIG. 10 illustrates a ride-on device 12 having a front board 14a and a rear board 14b with a connecting element 50 having elastic properties connected between the two boards 14a, b. In this embodiment, the front board 14a is attached to a steering column 52 having a wheel bracket 22 such that the wheel 20 is able to pivot about the axis of the steering column 52. A cam action caster assembly 10 is attached to the underside 18 of the rear board 14b, in the embodiment shown, and permits the rider to sustain a forward motion in the ride-on device 12 without taking his or her feet off of the boards 14a, b.

FIG. 12 shows a ride-on device 12 having one board 14 with two cam action caster assemblies 10 attached to either end of a rear portion of the underside of the board 14. In the rear center portion of the underside of the board 14 there is attached a fixed third wheel 20 to provide support during riding maneuvers conventionally known as “wheelies.” The front end of the board 14 is attached to a steering column 52 having a wheel bracket 22 such that a front wheel 20 is able to pivot about the axis of the steering column 52. The cam action caster assemblies 10 permit the rider to sustain a forward motion in the ride-on device 12 without taking his or her feet off of the board 14.

FIG. 11 illustrates a ride-on device 12 having a left member 15 and a right member 15, each member 15 having a foot platform 54 to support a rider. In particular, one of skill in the art will recognize that each platform 54 should have sufficient surface area and structural rigidity so as to support a rider's feet during use of the device 12. The members 14 are each attached to a bracket 56, in this embodiment, the attachments being pins or hinges 48 that permit the members 15 to pivot to the left and to the right while steering column 52 remains at the same nearly-vertical angle. There is also a support element 58, in this embodiment, pivotably attached on one end to a central portion of the left member 15 and on the other end to a central portion of the right member 15. The bracket 56 also is attached to a steering column 52, in this embodiment, and a wheel 20 that is able to rotate about the axis of the steering column 52. There are two cam action caster assemblies 10, in this embodiment, one attached to the underside of each foot platform 54, to permit the rider to sustain a forward motion in the ride-on device 12 without taking his or her feet off of the platforms 54.

A number of embodiments of the present invention have been presented herein. However, the invention may be used in the context of a device that is not ridden, such as a cart or wagon. In other embodiments, the invention could provide for a caster assembly using blades for use on ice rather than wheels. This disclosure is not intended to limit the invention in any way to the particular embodiments described, understanding that there are numerous alternative constructions. The invention is intended to cover the full scope of the subject matter as presented in the following claims.

What is claimed is:

1. A caster assembly for a ride-on device, the ride-on device having at least one base, the base having a top for supporting a user and a bottom, the caster assembly comprising:
a wheel;
a wheel bracket supporting the wheel and allowing free rotation of the wheel;
a shaft attachable to the bottom of the base and connected to the wheel bracket, the shaft permitting rotation of the wheel bracket around the shaft;
a cam track attachable to either of the bottom of the base or the wheel bracket, the cam track having a radius;
a cam follower engaging the cam track as the wheel bracket rotates around the shaft;
the cam track defining a cam track geometry having at least one valley and at least one peak; and
wherein the cam track geometry is functional to cause a distance between the wheel and the base to increase and decrease as the wheel bracket rotates around the shaft and the cam follower engages and moves about the cam track.

2. The caster assembly of claim 1, wherein the wheel bracket comprises a pivot hinge operable to increase or decrease the distance between the wheel and the base.

3. The caster assembly of claim 1, wherein the track geometry defined by the cam track comprises two valleys and two peaks.

4. The caster assembly of claim 1, wherein the track geometry defined by the cam track comprises four valleys and four peaks.

5. The caster assembly of claim 1, wherein the cam track is changeable.

6. The caster assembly of claim 5, wherein the cam follower is changeable so as to accommodate cam tracks of various radiuses.

7. The caster assembly of claim 1, wherein the wheel is changeable for an ice skate blade.

8. A ride-on apparatus for use by a rider on a riding surface, the apparatus comprising:
a platform having a bottom surface and a top surface adapted to support a rider's feet;
at least one caster assembly mounted to the bottom surface of the platform;
the caster assembly comprising
a shaft extending downwardly from the bottom surface of the platform, a wheel bracket engaging the shaft to allow rotation of the bracket around the shaft,
at least one wheel attached to the wheel bracket so that the wheel can contact the riding surface and rotate with respect to the wheel bracket as the apparatus is moved in a direction along the riding surface,
a cam track fixed to the bottom surface of the platform around the shaft,
a cam follower attached to the wheel bracket, the cam follower engaging the cam track as the wheel bracket rotates around the shaft; and
the cam track defining a varying track geometry such that, as the wheel bracket rotates around the shaft while the wheel is in contact with the riding surface, and as the cam follower engages and moves around the cam track, the board is caused to rise and fall with respect to the riding surface.

9. The apparatus of claim 8, wherein the cam track defines a track geometry that will cause the platform to rise to a maximum position when the wheel and wheel bracket are oriented transversely to the direction of movement of the platform along the riding surface.

10. The apparatus of claim 8, wherein the cam track defines a track geometry that will cause the platform to fall to a minimum position when the wheel and wheel bracket are aligned with the direction of movement of the platform along the riding surface.

11. The apparatus of claim 8, wherein the wheel and wheel bracket rotate around the shaft in response to lateral forces applied to the platform by movement of the rider.

12. The apparatus of claim 8, wherein the cam follower comprises two cam bearings attached to opposed sides of the wheel bracket.

13. The apparatus of claim 12, wherein the cam track has a radius, and the cam bearings are each attached to the wheel bracket at a distance from a center of the wheel bracket that is substantially equal to the radius of the cam track.

14. The apparatus of claim 8, wherein the shaft is attached at substantially a right angle to the bottom surface of the platform.

15. The apparatus of claim 8, the caster assembly further comprising:
a bushing engaging the shaft and the wheel bracket; and
a spring coiled around the shaft, the spring compressing as the board rises in response to a lateral force applied to the board, and the spring releasing as the board falls.

16. The ride-on apparatus of claim 15, wherein an energy generally commensurate with both the weight of the rider and a compression of the spring is stored as the board rises, and wherein the energy is released as the board falls.

17. A ride-on apparatus having a plurality of base members, the base members having a top side for supporting a rider and an underside, the apparatus comprising:
one or more connecting elements between the base members;
at least one caster assembly attached to the underside of at least one base member;
each caster assembly comprising
a shaft attached to and extending away from the underside of the base member,
a wheel bracket positioned proximate to the underside of the base member to rotate about the shaft,
at least one wheel rotatably attached to the wheel bracket, a cam mounted on the underside of the base member; and
a cam assembly connected to the wheel bracket and to the base member, the cam assembly operable to cause the base member to rise and fall as the wheel and wheel bracket rotate with respect to the base member.

18. The apparatus of claim 17, the cam assembly further comprising:
a cam track attached to one of the underside of the base member or the wheel bracket, the cam track defining a varying track geometry, and
a cam follower engaging the cam track as the wheel bracket rotates around the shaft.

19. The apparatus of claim 17, wherein the apparatus comprises two bases members, each base member having one caster assembly attached to the underside of the associated base member.

20. The apparatus of claim 17, wherein the apparatus comprises a front base member and a rear base member, the apparatus further comprising one caster assembly attached to the underside of the front base member and two caster assemblies attached to the underside of the rear base member.
